(19) United States
(12) Patent Application Publication
(10) Pub. No.: US 2026/0145957 A1
(43) Pub. Date: May 28, 2026

(54) METHODS FOR EXTRACTING AND RECOVERING HIGH-PURITY LITHIUM CARBONATE AND IRON PHOSPHATE FROM SPENT LITHIUM BATTERY MATERIAL

(71) Applicants: BEIJING UNIVERSITY OF TECHNOLOGY, Beijing (CN); CHANGZHOU HOUFENG NEW ENERGY CO., LTD., Changzhou (CN)

(72) Inventors: Yufeng WU, Beijing (CN); Xiaofei YIN, Changzhou (CN); Mengyu ZHAI, Beijing (CN); Zhi LI, Changzhou (CN); Jianghao DING, Changzhou (CN); Lu CAI, Changzhou (CN); Dan WU, Changzhou (CN); Huaidong WANG, Changzhou (CN)

(73) Assignees: BEIJING UNIVERSITY OF TECHNOLOGY, Beijing (CN); CHANGZHOU HOUFENG NEW ENERGY CO., LTD., Changzhou (CN)

(21) Appl. No.: 19/403,761

(22) Filed: Nov. 28, 2025

(30) Foreign Application Priority Data
Nov. 28, 2024 (CN) 202411721459.0

(51) Int. Cl. C01D 15/08; C01B 25/37; H01M 10/54

(52) U.S. Cl. CPC C01D 15/08; C01B 25/375; H01M 10/54

(57) ABSTRACT

Provided is a method for extracting and recovering high-purity lithium carbonate and iron phosphate from a spent lithium battery material. The method includes the following steps. In a first extraction stage, the iron phosphate feature data is input into an iron phosphate quality analysis model to obtain a first quality index at time T₁+a. Whether the extraction device is in an abnormal extraction state at time T₁+a is determined. If the abnormal extraction state occurs, an extraction adjustment instruction is generated, and the extraction device is adjusted. If not, a second extraction instruction is generated, and whether the extraction device is in an abnormal state at time T₂+b in a second extraction stage is determined. If the extraction device is in the abnormal extraction state, a second extraction adjustment instruction is generated, and the extraction device is adjusted. If not, extraction continues until extraction of lithium carbonate is completed.

### CROSS-REFERENCE TO RELATED APPLICATIONS

This application claims priority to the Chinese Patent Application No. 202411721459.0, filed on Nov. 28, 2024, the contents of which are hereby incorporated by reference.

### TECHNICAL FIELD

The present disclosure generally relates to a field of extraction and recovery technology, and in particular to a method for extracting and recovering high-purity lithium carbonate and iron phosphate from a spent lithium battery material.

### BACKGROUND

In the recycling of spent lithium batteries, lithium carbonate and iron phosphate, as important materials in battery manufacturing, have extremely high recycling value. Through an effective extraction and recovery process, not only can high-purity lithium carbonate be extracted from spent lithium batteries, but the cathode material iron phosphate is also recovered for preparing lithium iron phosphate batteries. However, traditional recovery ways have many shortcomings in process control, product purity, and resource utilization, such as complex processes, low efficiency, and difficulty in ensuring product purity. Therefore, how to introduce intelligent control throughout the recovery process, precisely manage each link, and ensure efficient recovery while improving product quality has become an important research direction in current spent lithium battery recovery technology.

In the existing technology, the absorbance of light at the same set wavelength by liquid in each extraction tank is obtained in real time. The obtained absorbance information is mapped to a concentration of a set element in the liquid in each extraction tank, and a balance point position is determined according to a distribution of the concentration of the set element in the liquid in each extraction tank. When the balance point position is not a preset position, prompt information for adjusting the process is generated or a flow rate of liquid flowing into the extraction tank is adjusted according to a relationship between the balance point position and the preset position. Although this way can achieve real-time monitoring and control of an extraction production line, research and application of the above way and existing technologies reveal that the control system has low precision, which may lead to over-adjustment or under-adjustment and cannot maintain a stable process.

Therefore, it is desirable to provide a method for extracting and recovering high-purity lithium carbonate and iron phosphate from a spent lithium battery material, which can adjust extraction parameters with high precision and maintain a stable process in real time.

### SUMMARY

One or more embodiments of the present disclosure provide a method for extracting and recovering high-purity lithium carbonate and iron phosphate from a spent lithium battery material. The method includes: step S1: in a first extraction stage, obtaining a first extraction control index at time T₁+a of an extraction device, and obtaining first characteristic data of a leach solution in the extraction device; labeling the first extraction control index and the first characteristic data as iron phosphate feature data; wherein T₁ and a are both integers greater than zero, and the first characteristic data includes an iron ion concentration, a viscosity of the leach solution, and an impurity percentage of the leach solution; step S2: inputting the iron phosphate feature data into a pre-built iron phosphate quality analysis model to obtain a first quality index at the time T₁+a; step S3: determining, according to the first quality index, whether the extraction device is in an abnormal extraction state at the time T₁+a; in response to determining that the extraction device is in the abnormal extraction state, generating an extraction adjustment instruction and jumping to step S4; in response to determining that the extraction device is not in the abnormal extraction state, generating a second extraction instruction and jumping to step S5; step S4: according to the extraction adjustment instruction, adjusting the extraction device based on the first quality index to optimize an extraction process and obtain high-purity iron phosphate; step S5: receiving the second extraction instruction, obtaining a second quality index at time T₂+b of the extraction device in a second extraction stage, and determining, based on the second quality index, whether the extraction device is in the abnormal extraction state at the time T₂+b; in response to determining that the extraction device is in the abnormal extraction state, generating a second extraction adjustment instruction and jumping to step S6; in response to determining that the extraction device is not in the abnormal extraction state, continuing extraction until extraction of lithium carbonate is completed; step S6: receiving the second extraction adjustment instruction, and adjusting the extraction device based on the second quality index to obtain high-purity lithium carbonate. A way of obtaining the first extraction control index at the time T₁+a of the extraction device includes: step a1, collecting first parameter characteristic data at time T₁, the first parameter characteristic data including a first temperature value, a first pH value, and a first stirring speed; labeling the first temperature value, the first pH value, and the first stirring speed as Wₛ₁, Ph₁, and Sd₁, respectively; step a2, performing a calculation on the first parameter characteristic data to obtain the first extraction control index at the time T₁, a calculation formula thereof being: θ₁=(Wₛ₁×α₁+Ph₁×α₂+Sd₁×α₃)+(μ₁×Ws₁×Ph₁); wherein θ₁ represents the first extraction control index at the time T₁, α₁ represents a weight factor of the first temperature value, α₂ represents a weight factor of the first pH value, α₃ represents a weight factor of the first stirring speed, and μ₁ represents a weighting coefficient of an interaction between the first temperature value and the first pH value; and step a3, inputting the first extraction control index at the time T₁ into a pre-built parameter analysis model to predict the first extraction control index at the time T₁+a; wherein the obtaining the second quality index of the extraction device at the time T₂+b includes: obtaining a second extraction control index of the extraction device at the time T₂+b and second characteristic data of an extraction mixture in the extraction device, and labeling a combination of the second extraction control index and the second characteristic data as lithium carbonate feature data; wherein the second characteristic data includes a lithium ion concentration, a viscosity of the extraction mixture, and an impurity percentage of the extraction mixture; inputting the lithium carbonate feature data into a pre-built lithium carbonate quality analysis model to obtain the second quality index at the time T₂+b; wherein the obtaining the second extraction control index of the extraction device at the time T₂+b includes: step d1, collecting second parameter characteristic data at the time T₂, the second parameter characteristic data including a second temperature value, a second pH value, and a second stirring speed; labeling the second temperature value, the second pH value, and the second stirring speed as Ws₂, Ph₂, and Sd₂, respectively; step d2, performing, based on the first extraction control index, a calculation on the second parameter characteristic data to obtain the second extraction control index at the time T₂, a calculation formula thereof being: θ₂=θ₁−(Ws₂×β₁+Ph₂×β₂+Sd₂×β₃)+(μ₂×Ws₂×Ph₂); wherein θ₂ represents the second extraction control index, β₁ represents a weight factor of the second temperature value, β₂ denotes a weight factor of the second pH value, β₃ represents a weight factor of the second stirring speed, μ₂ represents a weighting coefficient of an interaction between the second temperature value and the second pH value; and step d3, inputting the second extraction control index at the time T₂ into the pre-built parameter analysis model to predict the second extraction control index at the time T₂+b.

### Technical Effects and Advantages of the Present Disclosure

1. In the present disclosure, by obtaining the first extraction control index and the first characteristic data of the extraction device at time T₁+a and inputting them into the iron phosphate quality analysis model, a separation effect of iron phosphate in the first extraction stage can be predicted in real time. By obtaining the second extraction control index and the second characteristic data of the extraction device at time T₂+b and inputting them into the lithium carbonate quality analysis model, a separation effect of lithium carbonate in the second extraction stage can be predicted in real time. Based on different extraction stages and precise extraction control, errors in an operation process are effectively reduced, ensuring that an optimal temperature, pH value, and stirring speed are achieved during the extraction process, thereby improving product purity and recovery rate.
2. In the present disclosure, through the quality analysis models, an extraction state is predicted in real time, and an early warning is generated for the abnormal extraction state. When the extraction device is in the abnormal extraction state, the system automatically generates an adjustment instruction and performs adjustment according to an optimal adjustment strategy, ensuring that the extraction process returns to a normal state timely and reducing uncontrollable risks in the operation.

### BRIEF DESCRIPTION OF THE DRAWINGS

To more clearly illustrate the technical solutions in the embodiments of the present disclosure, the drawings used in the embodiments are briefly introduced below. It should be understood that the following drawings only show some embodiments of the present disclosure and therefore should not be considered as limiting the scope of the present disclosure.

FIG. 1 is a flowchart of a method for extracting and recovering high-purity lithium carbonate and iron phosphate from a spent lithium battery material according to some embodiments of the present disclosure.

FIG. 2 is a flowchart of a process for obtaining a first extraction control index of an extraction device at a time T₁+a according to some embodiments of the present disclosure.

FIG. 3 is a flowchart of a process for obtaining an impurity percentage of a leach solution according to some embodiments of the present disclosure.

FIG. 4 is a flowchart of a process for obtaining an optimal adjustment strategy according to some embodiments of the present disclosure.

### DETAILED DESCRIPTION

The technical solutions in the embodiments of the present disclosure will be clearly and completely described below with reference to the accompanying drawings in the embodiments of the present disclosure. Obviously, the described embodiments are merely some examples or embodiments of the present disclosure, rather than all of the embodiments. Based on the embodiments in the present disclosure, all other embodiments obtained by those of ordinary skill in the art without further creative efforts shall fall within the protection scope of the present disclosure.

In addition, the accompanying drawings are merely schematic illustrations of the present disclosure and are not necessarily drawn to scale. The same reference numerals in the drawings denote the same or similar parts, and thus repeated descriptions thereof will be omitted. Some block diagrams shown in the accompanying drawings are functional entities and do not necessarily correspond to physically or logically independent entities. The functional entities may be implemented in software form, or implemented in one or more hardware modules or integrated circuits, or implemented in different networks and/or processor methods and/or microcontroller methods.

It should be understood that although terms such as “first” and “second” may be used herein to describe various units, these units should not be limited by these terms. These terms are used only to distinguish one unit from another unit. For example, without departing from the scope of the exemplary embodiments, a first unit may be referred to as a second unit, and similarly, a second unit may be referred to as a first unit. The term “and/or” used herein includes any combinations of one or more of the associated listed items.

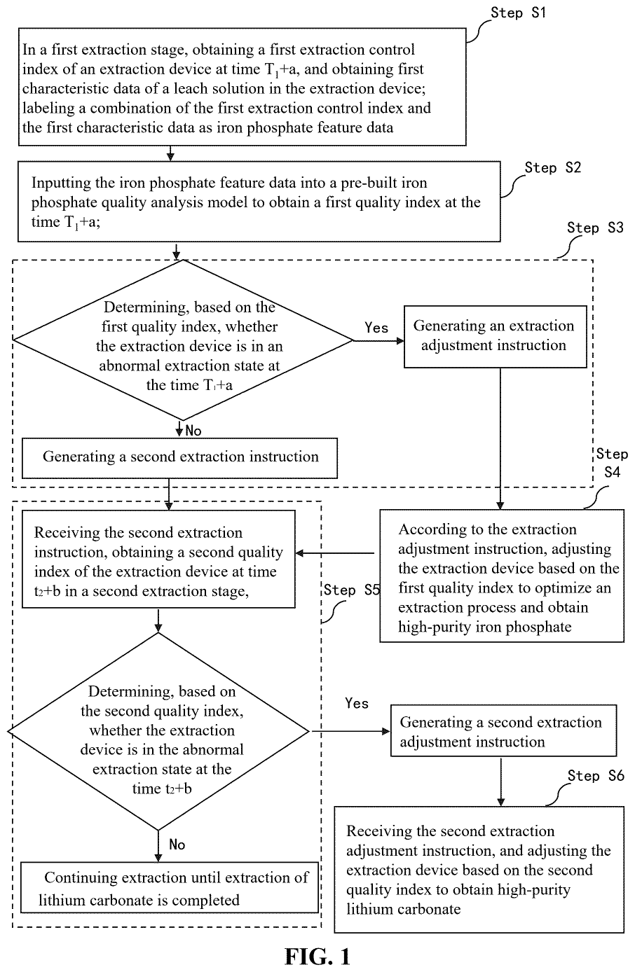

FIG. 1 is a flowchart of a method for extracting and recovering high-purity lithium carbonate and iron phosphate from a spent lithium battery material according to some embodiments of the present disclosure.

In some embodiments, as shown in FIG. 1, process 100 is executed by a processor. Process 100 includes steps 1-6.

In some embodiments, the processor includes a central processing unit (CPU), an application-specific integrated circuit (ASIC), an application-specific instruction set processor (ASIP), a physics processing unit (PPU), a digital signal processor (DSP), a processor, a microprocessor unit, a reduced instruction set computer (RISC), a microprocessor, or the like, or any combination thereof. In some embodiments, the processor is local or remote. In some embodiments, the processor is implemented on a cloud platform. Merely by way of example, the cloud platform includes a private cloud, a public cloud, a hybrid cloud, a community cloud, a distributed cloud, an internal cloud, a multi-layer cloud, or the like, or any combination thereof.
Step S1, in a first extraction stage, a first extraction control index of an extraction device at time T₁+a is obtained, and first characteristic data of a leach solution in the extraction device is obtained. A combination of the first extraction control index and the first characteristic data is labeled as iron phosphate feature data.

The first extraction stage refers to a stage for obtaining high-purity iron phosphate.

The extraction device refers to a solvent extractor for preparing high-purity lithium carbonate and iron phosphate. For example, the extraction device includes a mixer-settler, a centrifugal extractor, a pulsed sieve plate extraction column, or the like.

In some embodiments, the solvent extractor at least includes a leaching reaction kettle, a pH automatic control system, a temperature control system, a filtration and centrifugation device, an automatic stirring system, etc.

The leaching reaction kettle is configured to mix the spent lithium battery material with a solvent for preliminary dissolution and reaction.

The pH automatic control system is configured to monitor and adjust the pH value of the solution to ensure separation conditions for iron phosphate and lithium carbonate.

The temperature control system includes a heating system and a cooling system. The temperature control system dynamically adjusts the temperature in the leaching reaction kettle based on feedback from a temperature sensor to ensure optimal precipitation conditions.

The filtration and centrifugation device is configured to separate precipitated solid substances, such as iron phosphate and lithium carbonate.

The automatic stirring system is configured to ensure uniform mixing of the extractant and the spent lithium battery material, and to prevent precipitation or insufficient local reaction.

T₁ refers to a start time of the first extraction stage. a refers to a time period during which extraction is performed in the first extraction stage. In some embodiments, a value of a is determined by the sliding window length and a sampling period.

In some embodiments, both T₁ and a are integers greater than zero.

The first extraction control index refers to a parameter for controlling the extraction device to perform extraction in the first extraction stage.

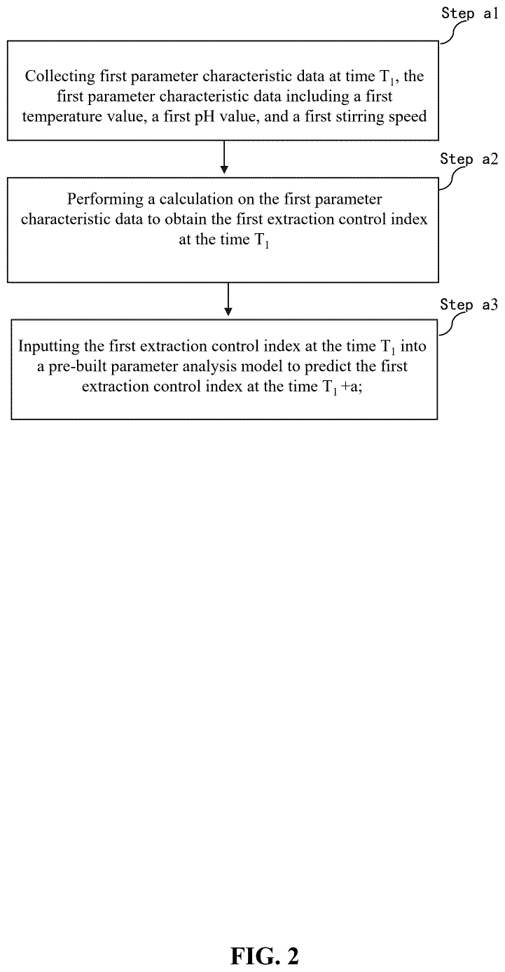

FIG. 2 is a flowchart of a process for obtaining a first extraction control index at a time T₁+a according to some embodiments of the present disclosure.

In some embodiments, as shown in FIG. 2, the processor obtains the first extraction control index through the following steps a1-a3.
Step a1, first parameter characteristic data at time T1 is collected, where the first parameter characteristic data include a first temperature value, a first pH value, and a first stirring speed.

The first parameter characteristic data refers to parameters characterizing an operating state of the extraction device in the first extraction stage.

The first temperature value refers to a temperature value of the extraction device in the first extraction stage. The first pH value refers to a pH value in the extraction device in the first extraction stage. The first stirring speed refers to a stirring speed of the extraction device in the first extraction stage.

It should be noted that the first temperature value is collected by a temperature sensor connected to the temperature control system; the first pH value is collected by a pH meter connected to the pH automatic control system. The first stirring speed is collected by a speed sensor connected to the automatic stirring system.
Step a2, a calculation on the first parameter characteristic data is performed to obtain a first extraction control index at the time T₁.

The calculation formula is:

$${θ}_{1} = ( W {s}_{1} \times {α}_{1} + P {h}_{1} \times {α}_{2} + S {d}_{1} \times {α}_{3} ) + ( {μ}_{1} \times W {s}_{1} \times P {h}_{1} ) ;$$

In the formula, θ₁ represents the first extraction control index at the time T₁, Wₛ₁ represents the first temperature value, α₁ represents a weight factor of the first temperature value, Ph₁ represents the first pH value, α₂ represents a weight factor of the first pH value, Sd₁ represents the first stirring speed, α₃ represents a weight factor of the first stirring speed, and μ₁ represents a weighting coefficient for interaction between the first temperature value and the first pH value.

A larger value of μ₁ indicates that the interaction between the first temperature value and the first pH value has a more significant impact on extraction efficiency; a larger value of the first parameter characteristic data results in a larger first extraction control index, conversely, a smaller value of the first parameter characteristic data results in a smaller first extraction control index; the calculation of the first extraction control index is a dimensionless calculation.

The weight factors α₁, α₂, and α₃ are set based on actual conditions, μ₁ is determined by a technician based on historical data, each weight factor reflects an influence degree of each type of first parameter characteristic data on an actual extraction purity of iron phosphate extracted by the extraction device, a person skilled in the art presets a corresponding weight factor according to the influence degree of each type of first parameter characteristic data on the actual extraction purity of iron phosphate extracted by the extraction device, so as to accurately evaluate an actual purity of iron phosphate extracted by the extraction device.
Step a3, the first extraction control index at time T₁ is input into a pre-built parameter analysis model to predict a first extraction control index at time T₁+a.

The pre-built parameter analysis model (also referred to as the parameter analysis model) refers to a model used for predicting the first extraction control index. In some embodiments, the parameter analysis model is a recurrent neural network model. The recurrent neural network model is a Recurrent Neural Network (RNN).

In some embodiments, an input of the parameter analysis model includes the first extraction control index at time T₁, and an output includes the first extraction control index at time T₁+a.

In some embodiments, a processor obtains historical first extraction control indices, establishes an extraction time series set based on the historical first extraction control indices, where the extraction time series set includes u historical first extraction control indices, the u historical first extraction control indices are obtained at equal time intervals, and the u historical first extraction control indices correspond to a preset time; a unit of the preset time is second or minute; presets a sliding step size and a sliding window length; converts the u historical first extraction control indices in the extraction time series set into a plurality of training samples using a sliding window manner, uses the plurality of training samples as input to the recurrent neural network model, uses a first extraction control index after the sliding step size as output, uses the first extraction control index of each training sample of the plurality of training samples as a prediction target, uses a prediction accuracy as a training objective, and trains the recurrent neural network model; generates the parameter analysis model that predicts a first extraction control index at a future time based on the u historical first extraction control indices in the extraction time series set; wherein the recurrent neural network model is an RNN.

The extraction time series set refers to a collection of a plurality of historical first extraction control indices that change over time.

In some embodiments, the extraction time series set includes u historical first extraction control indices.

In some embodiments, the u historical first extraction control indices in the extraction time series set are obtained at equal time intervals, and the u historical first extraction control indices correspond to a preset time. The preset time refers to a pre-set time period, i.e., the u historical first extraction control indices correspond to a plurality of time points within a time range. A unit of the preset time is a second or a minute. In some embodiments, the preset time is preset by a technician based on experience.

The sliding step size refers to a length by which the sliding window moves. The sliding window refers to a selection box for selecting a portion of consecutive historical first extraction control indices in the extraction time series set.

In some embodiments, the sliding step size is pre-set by a technician based on experience.

The sliding window length refers to a count of historical first extraction control indices selected by the sliding window.

In some embodiments, a larger sliding window length results in the sliding window selecting more consecutive historical first extraction control indices.

In some embodiments, the sliding window length is pre-set by a technician based on experience.

In some embodiments, the processor determines an extraction sub-stage to which an extraction process belongs according to a fluctuation degree of the first extraction control index within the preset time, the extraction sub-stage including an initial reaction stage, an intermediate stabilization stage, and a final finishing stage; determines the sliding window length and the sliding step size according to a current extraction sub-stage, including: in response to the current extraction sub-stage being the initial reaction stage, determine the sliding window length as a first window length and the sliding step size as a first step size; in response to the current extraction sub-stage being the intermediate stabilization stage, determine the sliding window length as a second window length and the sliding step size as a second step size; in response to the current extraction sub-stage being the final finishing stage, determine the sliding window length as a third window length and the sliding step size as a third step size; wherein the first window length is greater than the third window length, the second window length is less than the third window length, the second step size is greater than the third step size, and the first step size is less than the third step size.

The fluctuation degree refers to a parameter for measuring a stability level of the first extraction control index within the preset time.

In some embodiments, the processor determines the fluctuation degree of the first extraction control index within the preset time based on a standard deviation of a plurality of first extraction control indices within the preset time.

The extraction sub-stage refers to a plurality of process sub-stages within the first extraction stage. In some embodiments, the extraction sub-stage includes the initial reaction stage, the intermediate stabilization stage, and the final finishing stage.

The initial reaction stage refers to a stage where an initial precipitation reaction of iron ions in the extraction device is relatively intense when extraction begins. In some embodiments, when the first extraction stage is the initial reaction stage, a material concentration, the first temperature value, and the first pH value in the extraction device are not yet stable, the initial precipitation reaction of iron ions is relatively intense, and the fluctuation degree of the first extraction control index is relatively large. For example, a standard deviation of differences between the first extraction control indices before and after each minute within the preset time is used as the fluctuation degree. A relatively large fluctuation degree corresponds to a value greater than a first preset threshold. Merely by way of example, the first preset threshold is 0.08.

The intermediate stabilization stage refers to a stage where parameters such as temperature and pH value in the extraction device tend to stabilize after the reaction has proceeded for a period of time. In some embodiments, when the first extraction stage is the intermediate stabilization stage, parameters such as the first temperature value, the first pH value, and the first stirring speed in the extraction device tend to stabilize, and the fluctuation degree of the first extraction control index decreases significantly. A decreased fluctuation degree corresponds to a value less than a second preset threshold. Merely by way of example, the second preset threshold is 0.05.

The final finishing stage refers to a stage where the reaction is nearing completion. In some embodiments, when the first extraction stage is the final finishing stage, the Fe³⁺ concentration in the extraction device decreases, and an increase in an impurity ratio is likely to cause disturbance, resulting in a moderate fluctuation degree of the first extraction control index. A moderate fluctuation degree corresponds to a value between the first preset threshold and the second preset threshold.

In some embodiments, the processor determines the extraction sub-stage based on the fluctuation degree of the first extraction control index within the preset time. For example, if the standard deviation corresponding to the fluctuation degree is 0.03, and it is determined that this standard deviation is less than the second preset threshold of 0.05, then the current extraction sub-stage is determined to be the intermediate stabilization stage.

The first window length refers to a sliding window parameter used in the initial reaction stage.

It is understandable that, because the reaction has just started in the initial reaction stage and the fluctuation degree is large, in order to capture a complete dynamic process and improve a response capability of the model to sudden changes, the sliding window length should be set to a relatively long value (e.g., 12 to 20 sampling points) to increase the sampling density. The first step size refers to a sliding step size used in the initial reaction stage.

It is understandable that, because the reaction has just started in the initial reaction stage and the fluctuation degree is large, in order to capture a complete dynamic process and improve the response capability of the model to sudden changes, the sliding step size should be set to a relatively small value (e.g., 1 to 2) to increase the sampling density.

The second window length refers to a sliding window parameter used in the intermediate stabilization stage.

It is understandable that, because the system is stable and the fluctuation degree is small in the intermediate stabilization stage, in order to improve computational efficiency and avoid redundancy, the sliding window length is set to a relatively short value (e.g., 6 to 8 sampling points).

The second step size refers to a sliding step size used in the intermediate stabilization stage.

It is understandable that, because the system is stable and the fluctuation degree is small in the intermediate stabilization stage, in order to improve computational efficiency and avoid redundancy, the sliding step size is set to a relatively large value (e.g., 5 to 6) to reduce the frequency of repeated sampling.

The third window length refers to a sliding window parameter used in the final finishing stage.

It is understandable that, because the reaction is nearing completion in the final finishing stage, but impurity disturbance or control oscillation occurs, resulting in a moderate fluctuation degree, the sliding window length is set to a medium value (e.g., 8 to 12 sampling points).

The third step size refers to a sliding step size used in the final finishing stage.

It is understandable that, because the reaction is nearing completion in the final finishing stage, impurity disturbance or control oscillation occurs, resulting in a moderate fluctuation degree. The sliding step size is also set to a medium value (e.g., 3 to 4) to maintain an appropriate monitoring frequency.

In some embodiments, the first window length is greater than the third window length, the second window length is less than the third window length, the second step size is greater than the third step size, and the first step size is less than the third step size.

In some embodiments, by dynamically dividing the first extraction stage into stages based on the fluctuation degree of the first extraction control index and accordingly setting matching sliding window lengths and step sizes, the parameter analysis model more accurately adapts to process variation characteristics of different stages, improving the reliability of prediction results.

The sliding window manner refers to a way of selecting a plurality of consecutive historical first extraction control indices using a sliding window.

In some embodiments, a plurality of consecutive historical first extraction control indices selected by a sliding window serve as a training sample. Based on a sliding step size, the sliding window moves continuously and selects a plurality of different consecutive historical first extraction control indices, thereby obtaining a plurality of different training samples.

In some embodiments, a processor trains a recurrent neural network based on a plurality of first training samples with first training labels. A first training sample includes a plurality of consecutive historical first extraction control indices. A first training label corresponding to a first training sample is a first historical first extraction control index selected by the sliding window after a next sliding step size.

In some embodiments, the processor inputs the plurality of first training samples with the first training labels into the recurrent neural network, constructs a loss function through the first training labels and a result of the recurrent neural network, and iteratively updates parameters of the recurrent neural network based on the loss function through various ways. For example, updating is performed based on a gradient descent way, etc. In response to a determination that the loss function of the recurrent neural network satisfies a first preset condition, model training is completed, and a trained parameter analysis model is obtained. The first preset condition includes that the loss function converges, an iteration count reaches a threshold, etc.

In some embodiments, training samples obtained through a sliding window are used to train a model, which can maximize utilization of historical data and has strong sample overlap, thereby averaging training sample noise and making the trained parameter analysis model more stable.

The leach solution refers to an acidic aqueous solution obtained after a spent lithium battery is dissolved and filtered.

In some embodiments, the leach solution includes useful components (e.g., iron ions and lithium ions) dissolved from solid substances (e.g., graphite, aluminum foil, LiFePO₄ particles, etc.) and undissolved impurities.

In some embodiments, a technician adds a spent lithium battery to sulfuric acid, and a clarified filtrate obtained after a solid residue is dissolved and filtered is the leach solution.

The first characteristic data refers to data reflecting characteristics of the leach solution.

In some embodiments, the first characteristic data includes an iron ion concentration, a viscosity of the leach solution, and an impurity percentage of the leach solution.

The iron ion concentration is directly analyzed by a concentration analysis device to determine the concentration of iron ions. A higher iron ion concentration indicates more iron content extracted from the leach solution in the first extraction stage, which helps determine the effect and efficiency of iron phosphate extraction. The viscosity of the leach solution is measured by a rotational viscometer or a capillary viscometer. A higher viscosity affects fluidity and mass transfer efficiency and also indicates a higher presence of solid suspended matter (iron phosphate). The concentration analysis device includes an Inductively Coupled Plasma-Optical Emission Spectrometer (ICP-OES), an Atomic Absorption Spectrometer (AAS) device, etc.

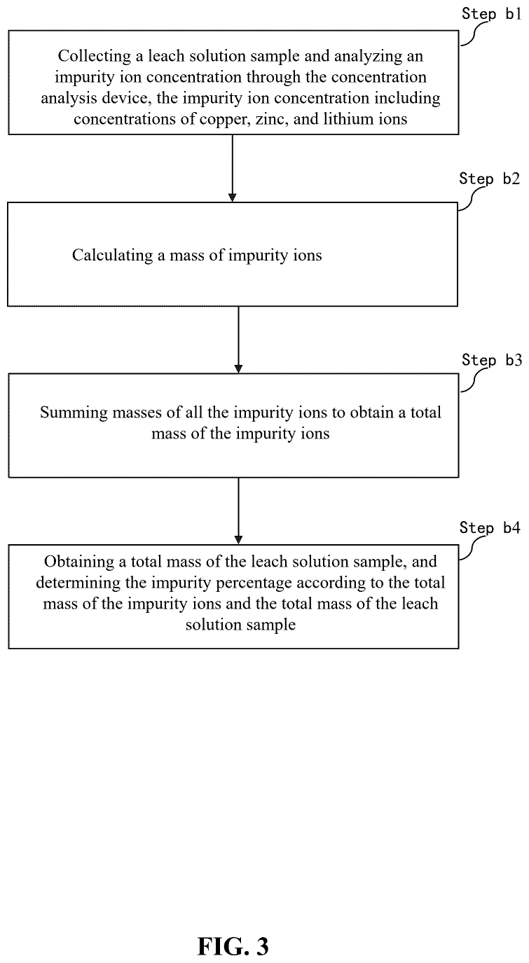

FIG. 3 is a flowchart illustrating a process for obtaining an impurity percentage of a leach solution according to some embodiments of the present disclosure.

In some embodiments, as shown in FIG. 3, the processor obtains the impurity percentage of the leach solution through the following step b1 to step b4.

Step b1, a leach solution sample is collected, and an impurity ion concentration is analyzed through the concentration analysis device. The impurity ion concentration includes concentrations of copper, zinc, and lithium ions.

The leach solution sample refers to a portion of liquid extracted from the leach solution.

In some embodiments, the impurity ion concentration includes concentrations of copper, zinc, and lithium ions.
Step b2, the mass of impurity ions is determined.

For example, the mass of impurity ions is determined through a formula mᵢ=Cᵢ×V where mᵢ represents the mass of an i-th impurity ion, Cᵢ represents the concentration of the i-th impurity ion, and V represents the volume of the leach solution sample.
Step b3, the masses of all impurity ions are accumulated to obtain the total mass of the impurity ions. For example, mₜₒₜₐₗ=Σmᵢ.
Step b4, the total mass of the leach solution sample is obtained, and the impurity percentage is determined based on the total mass of the impurity ions and the total mass of the leach solution sample.

For example, the impurity percentage is determined by the following formula

$$Zbf = \frac{{m}_{t o t a l}}{{M}_{l each solution}} \times 100 \% ,$$

where Zbf is the impurity percentage, M_{leach solution} is the total mass of the leach solution sample, and mₜₒₜₐₗ is the total mass of the impurity ions.

It should be noted that the total mass M_{leach solution} of the leach solution sample is measured in advance by an electronic balance and pre-stored in a system database.

In some embodiments, the impurity percentage determined through the impurity ion concentration may reduce the sampling process and improve data calculation efficiency.

The iron phosphate feature data refers to data reflecting a quality of an extraction condition in the first extraction stage and the quality of the leach solution.

In some embodiments, the processor combines the first extraction control index and the first characteristic data to construct the iron phosphate feature data.

It should be noted that, in the first extraction stage, a first extractant with a preset concentration is added to the leach solution, and D2EHPA (Di(2-ethylhexyl) phosphoric acid) is selected as a selective extractant for iron. A purpose of setting the first extraction stage is to optimize the precipitation efficiency of iron phosphate under different conditions, avoid impurity generation, improve product purity, and ensure the stability and a high recovery rate of the extraction stage. Conditions of the first extraction stage (e.g., conditions of the first extraction stage include the pH value, the temperature, and the stirring speed) are precisely controlled for the leach solution, thereby ensuring the optimal purity of iron phosphate extraction.
Step S2, the iron phosphate feature data is input into a pre-built iron phosphate quality analysis model to obtain the first quality index at time T₁+a.

The pre-built iron phosphate quality analysis model (also referred to as the iron phosphate quality analysis model) refers to a model for obtaining the first quality index. In some embodiments, the iron phosphate quality analysis model is a deep neural network model or a deep belief network model.

In some embodiments, the input of the iron phosphate quality analysis model is the iron phosphate feature data, and the output is the first quality index.

In some embodiments, the processor trains the iron phosphate quality analysis model in various ways.

In some embodiments, the processor converts each set of iron phosphate feature data into a form of a first feature vector. All elements of the first feature vectors serve as inputs of the iron phosphate quality analysis model. The iron phosphate quality analysis model uses the first quality index predicted for each set of iron phosphate feature data as an output and uses an actual first quality index corresponding to each set of iron phosphate feature data as a prediction target. A training objective is to minimize the sum of the first prediction accuracies of all predicted first quality indices. The iron phosphate quality analysis model is trained until the sum of the first prediction accuracies converges, and training is stopped.

The first feature vector refers to a vector representation reflecting the iron phosphate feature data. In some embodiments, elements in the first feature vector are the iron phosphate feature data.

In some embodiments, the processor converts the iron phosphate feature data into the first feature vector based on a vector conversion way. The vector conversion way includes first combining the iron phosphate feature data into a one-dimensional array and performing standardization processing on the array.

In some embodiments, the processor uses the actual first quality index corresponding to each set of iron phosphate feature data as the prediction target.

In some embodiments, the training objective is that the sum of the first prediction accuracies of all predicted first quality indices reaches a minimum value.

In some embodiments, the calculation formula of the first prediction accuracy is: Z1=(aₙ−yₙ)².
where n is a serial number of each set of iron phosphate feature data, Z₁ is the first prediction accuracy, an is a predicted first quality index corresponding to an n-th set of iron phosphate feature data, and yₙ is an actual first quality index corresponding to the n-th set of iron phosphate feature data.

In some embodiments, the processor trains the iron phosphate quality analysis model based on a plurality of second training samples with prediction targets. A second training sample includes a historical first feature vector. A prediction target corresponding to a second training sample is an actual historical first quality index corresponding to historical iron phosphate feature data. A prediction target is determined by a technician based on historical data.

In some embodiments, the processor inputs a plurality of second training samples with prediction targets into an initial iron phosphate quality analysis model, constructs a loss function based on the prediction targets and results of the initial iron phosphate quality analysis model, and iteratively updates parameters of the initial iron phosphate quality analysis model based on the loss function in various ways. For example, updating is performed based on gradient descent or the like. When the loss function of the initial iron phosphate quality analysis model meets a training objective, model training is completed, and a trained iron phosphate quality analysis model is obtained. It is understandable that the first prediction accuracy is the square of the deviation between the predicted first quality index and the historical first quality index corresponding to the prediction target. The closer the predicted first quality index is to the historical first quality index, the smaller the square of the deviation, the smaller the first prediction accuracy, and the smaller the sum of the plurality of first prediction accuracies is. When all first prediction accuracies reach a minimum, the sum of all first prediction accuracies is minimized. At this time, the predicted first quality index output by the iron phosphate quality analysis model is closest to the actual historical first quality index, indicating good prediction performance, and training is terminated.

In some embodiments, mapping the feature vector directly to a purity value may eliminate the need for manual empirical coefficients, allow the model to automatically capture nonlinear interactions, and use (aₙ-yₙ)₂ as the loss, make the training process observable, and allow training to be stopped early.

It should be noted that the first quality index specifically refers to the purity of the iron phosphate extracted and recovered in the first extraction stage. The actual first quality index corresponding to the prediction target is obtained by measurement using ways such as Inductively Coupled Plasma Optical Σmission Spectrometry (ICP-OES) or X-ray Fluorescence (XRF).
Step S3, whether the extraction device is in an abnormal extraction state at time T₁+a is determined based on the first quality index. It is known that there are two situations where the extraction device is in the abnormal extraction state and the extraction device is not in the abnormal extraction state, i.e., in a normal state. In response to determining that the extraction device is in the abnormal extraction state, an extraction adjustment instruction is generated, and step S4 is jumped to. In response to determining that the extraction device is not in the abnormal extraction state, a second extraction instruction is generated, and step S5 is jumped to.

The abnormal extraction state refers to a state where the purity of the iron phosphate deviates from a qualified range.

It is understandable that if the abnormal extraction state occurs, the recovery rate of the iron phosphate by the extraction device will decrease, or the risk of impurity co-precipitation in the leach solution will significantly increase, leading to process failure.

In some embodiments, the processor labels the first quality index at time T₁+a predicted by the iron phosphate quality analysis model as Zls. A first index threshold is preset, the first index threshold includes S₁ and S₂, and S₁>S₂. The first quality index is compared with the preset first index threshold. If Zls>S₁ or Zls<S₂, it is determined that the extraction device is in the abnormal extraction state at time T₁+a. If S₁≥Zls≥S₂, it is determined that the extraction device is in a normal extraction state at time T₁+a, extraction is continued by completing extraction with the first parameter characteristic data corresponding to the first extraction control index, and the process enters the second extraction stage.

The first index threshold refers to a parameter used to determine whether the extraction device is in an abnormal state during the first extraction stage. In some embodiments, the first index threshold includes two values, S₁ and S₂, wherein S₁>S₂.

In some embodiments, the first index threshold is determined by a technician based on historical data.

It should be noted that the preset first index threshold in the first extraction stage is determined by a person skilled in the art by repeatedly obtaining iron phosphate feature data, wherein Q groups of iron phosphate feature data are obtained each time, a mean of the Q groups of iron phosphate feature data is determined, the first quality index corresponding to the mean of the iron phosphate feature data is predicted by the iron phosphate quality analysis model, a plurality of first quality indices are sorted, a maximum value among the plurality of first quality indices is taken as a maximum value S₁ of the first index threshold, and a minimum value among the plurality of first quality indices is taken as a minimum value S2 of the first index threshold. The range from the minimum value S2 of the first index threshold to the maximum value S₁ of the first index threshold is the numerical range corresponding to the preset first index threshold.

In some embodiments, determining whether the abnormal extraction state exists using the first index threshold can reduce the number of system comparisons, reduce errors, and improve real-time monitoring efficiency.

The second extraction instruction refers to an instruction for controlling the extraction device to perform extraction in the second extraction stage.
Step S4, the extraction device is adjusted based on the first quality index according to the first extraction adjustment instruction to optimize the extraction process and obtain high-purity iron phosphate.

The first extraction adjustment instruction refers to an instruction for adjusting the abnormal extraction state in the extraction device. The first extraction adjustment instruction is the extraction adjustment instruction.

For example, the first extraction adjustment instruction is to reduce the temperature to 53° C., reduce the pH value to 4.2, and reduce the stirring speed to 250 rpm.

In some embodiments, in response to the abnormal extraction state existing in the extraction device, the processor generates the extraction adjustment instruction based on the first quality index and sends the extraction adjustment instruction to the extraction device to optimize the extraction process and obtain high-purity iron phosphate.

In some embodiments, the processor further inputs the first parameter characteristic data corresponding to the first quality index into a pre-built digital twin model for simulation to obtain an optimal adjustment strategy. In some embodiments, the processor uses the optimal adjustment strategy as the extraction adjustment instruction.

It should be noted that the pre-built digital twin model is specifically a virtual simulation model of a production workshop. The digital twin model is generated based on various types of historical measured data of the production workshop, and real-time data and model are updated based on a plurality of sensors. The various types of historical measured data include physical data, equipment operating parameters, object structure data, etc. The pre-built digital twin model is implemented relying on existing digital twin construction technologies, such as ANSYS, Azure Digital Twins, Siemens Mindsphere, etc. Therefore, this is not described in detail in the present disclosure.

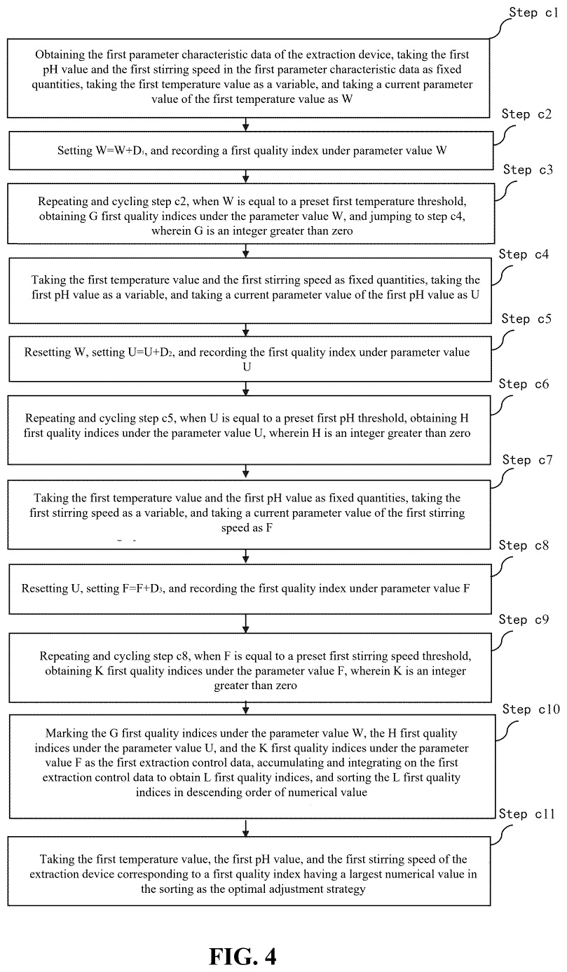

FIG. 4 is a flowchart of a process for obtaining an optimal adjustment strategy according to some embodiments of the present disclosure.

In some embodiments, as shown in FIG. 4, the processor obtains the optimal adjustment strategy through the following steps c1 to c11.
Step c1, first parameter characteristic data of the extraction device is obtained, a first pH value and a first stirring speed in the first parameter characteristic data are used as fixed quantities, a first temperature value is used as a variable, and a current parameter value of the first temperature value is used as W.

In some embodiments, the first pH value and the first stirring speed are used as fixed quantities and remain unchanged in the extraction device. The first temperature value is used as a variable. The processor controls a heating device (e.g., a heat transfer fluid heater) to gradually increase the temperature of the extraction device based on the current parameter value W of the first temperature value to achieve variable change.

A way for obtaining the current parameter value of the first temperature value is the same as the way for obtaining the first temperature value. Related content may be found in the description related to step S1 above.
Step c2, W=W+D1 is set, and the first quality index at the parameter value W is recorded, where D1 is a natural number greater than zero.

It is understandable that the first temperature value is used as the variable. The heating device increases the temperature of the extraction device based on the current parameter value W of the first temperature value, and the temperature increase amount is D1. The processor uses the increased temperature as the current parameter W of the first temperature value and simultaneously records the first quality index at the current parameter W of the first temperature value, the first pH value, and the first stirring speed.
Step c3, step c2 is repeated and cycled. When W equals a preset first temperature threshold, G first quality indices at the current parameter value of the first temperature value are obtained, and proceeding to step c4, where G is an integer greater than zero.

In some embodiments, the current parameter value of the first temperature value is the first temperature parameter value.

It is understandable that when the heating device heats the first temperature value of the extraction device to the preset first temperature threshold (also referred to as the first temperature threshold) (i.e., after repeatedly performing step c2 multiple times, the current parameter value W of the first temperature value reaches the first temperature threshold), heating is stopped, and finally G first quality indices are obtained. The value of G is the number of times the heating device heats the extraction device.

The first temperature threshold refers to a parameter used for screening the first quality index.

In some embodiments, the first temperature threshold is preset by a technician based on experience.
Step c4, the first temperature value and the first stirring speed are used as fixed quantities, the first pH value is used as a variable, and a current parameter value of the first pH value is used as U.

In some embodiments, the first temperature value and the first stirring speed are used as fixed quantities and remain unchanged in the extraction device. The first pH value is used as a variable. The processor gradually increases the alkalinity inside the extraction device based on the current parameter value U of the first pH value through an acid-base titration device (e.g., an acid-base titration pump) to achieve a variable change.

A way for obtaining the current parameter value of the first pH value is the same as the way for obtaining the first pH value. Related content may be found in the description related to step S1 above.
Step c5, W is reset, U=U+D2 is set, and the first quality index at the parameter value U is recorded, where D2 is a natural number greater than zero.

It is understandable that the first pH value is used as the variable. The titration device increases the alkalinity in the extraction device based on the current parameter value U of the first pH value, and the alkalinity increase amount is D2. The processor uses the pH value after the alkalinity increase as the current parameter value U of the first pH value and simultaneously records the first quality index at the current parameter value U of the first pH value, the first temperature value, and the first stirring speed. Among them, since the first temperature value is a fixed quantity, the processor controls the extraction device to cool down to the parameter value W before heating, before increasing the alkalinity.
Step c6, step c5 is repeated and cycled. When U equals a preset first pH threshold, obtaining H first quality indices at the current parameter value of the first pH value, where His an integer greater than zero.

In some embodiments, the current parameter value of the first pH value is the preset first pH threshold (also referred to as the first pH parameter value).

The first pH threshold refers to a maximum value that the first pH value can achieve when the first pH value is used as the variable.

In some embodiments, the first pH threshold is preset by a technician based on experience.

It is understandable that when the titration device titrates the first pH value of the extraction device to the first pH threshold (i.e., after repeatedly performing step c5 multiple times, the current parameter value U of the first pH value reaches the first pH threshold), titration is stopped, and finally H first quality indices are obtained. The value of His the number of times the titration device titrates into the extraction device.
Step c7, the first temperature value and the first pH value are used as fixed quantities, the first stirring speed is used as a variable, and a current parameter value of the first stirring speed is used as F.

In some embodiments, the first temperature value and the first pH value are fixed quantities and remain unchanged in the extraction device, and the first stirring speed is a variable. The processor gradually increases the stirring speed in the extraction device based on a current parameter value F of the first stirring speed by driving a motor to achieve variable change.

A way for obtaining the current parameter value of the first stirring speed is the same as the way for obtaining the first stirring speed. Related content may be referred to the description related to step S1 above.
Step c8, U is reset, F=F+D3 is set, and the first quality index under the parameter value F is recorded, where D3 is a natural number greater than zero.

Understandably, with the first stirring speed as the variable, the motor increases the stirring speed in the extraction device based on the current parameter value F of the first stirring speed. The increase amount of the stirring speed is D3. The processor sets the increased stirring speed as the current parameter value F of the first stirring speed and simultaneously records the first quality index under the first pH value, the first temperature value, and the current parameter value F of the first stirring speed. Since the first pH value is a fixed quantity, the processor controls a titration device to reduce the alkalinity in the extraction device to the parameter value U before the alkalinity increases, before increasing the stirring speed.
Step c9, step c8 is repeated and cycled. When F equals a preset first stirring speed threshold, K first quality indices under the current parameter value of the first stirring speed are obtained, where K is an integer greater than zero.

In some embodiments, the current parameter value of the first stirring speed is also the first stirring speed parameter value.

The first stirring speed threshold refers to a maximum value that the first stirring speed can achieve when it is a variable.

In some embodiments, the first stirring speed threshold is preset by a technician based on experience.

Understandably, when the motor increases the first stirring speed of the extraction device to the first stirring speed threshold (i.e., after multiple repetitions of step c8, the current parameter value F of the first stirring speed reaches the first stirring speed threshold), acceleration is stopped, and finally K first quality indices are obtained. The value of K is the number of times the motor increases the first stirring speed of the extraction device.
Step c10, the G first quality indices under the first temperature parameter value, the H first quality indices under the first pH parameter value, and the K first quality indices under the first stirring speed parameter value are marked as first extraction control data. Accumulating and integrating are performed on the first extraction control data to obtain L first quality indices, and the L first quality indices are sorted in descending order of their numerical values.

The first extraction control data refers to all first quality indices under single-variable scanning.

Understandably, the accumulating and integrating of the first extraction control data involves combining all first quality indices into a large data set. The data set includes L first quality indices, where L=G+H+K.
Step c11, the first temperature value, the first pH value, and the first stirring speed of the extraction device corresponding to the first quality index with the largest value in the sorting are used as an optimal adjustment strategy.

It should be noted that the value range of the first temperature value is [40° C., 60° C.], the value range of the first pH value is [3, 5], and the value range of the first stirring speed is [100 rpm, 300 rpm]. The current parameter values in the above steps start from the minimum value of the corresponding parameter and are simulated until the optimal adjustment strategy is obtained.

In some embodiments, in the first extraction stage, the value range of the first temperature value in the first parameter characteristic data is one of [40° C., 45° C.], [45° C., 50° C.], [50° C., 55° C.], [55° C., 60° C.], etc.

In some embodiments, in the first extraction stage, the value range of the first pH value in the first parameter characteristic data is one of [3, 3.5], [3.5, 4], [4, 4.5], [4.5, 5], etc.

In some embodiments, in the first extraction stage, the value range of the first stirring speed in the first parameter characteristic data is one of [100 rpm, 120 rpm], [120 rpm, 140 rpm], [140 rpm, 160 rpm], [160 rpm, 180 rpm], [180 rpm, 200 rpm], [200 rpm, 220 rpm], [220 rpm, 240 rpm], [240 rpm, 260 rpm], [280 rpm, 300 rpm], etc.

The optimal adjustment strategy refers to a parameter combination capable of obtaining high-purity iron phosphate, screened through simulation by the digital twin model. In some embodiments, the optimal adjustment strategy includes the first temperature value, the first pH value, and the first stirring speed that can be used to obtain high-purity iron phosphate.

In some embodiments, single-variable scanning in turn keeps the computational load controllable. The digital twin model provides purity estimates instantly without on-site testing, avoiding waste from multiple batches caused by manual parameter adjustment. Each variable only slides within its interval, automatically meeting equipment mechanical and corrosion limits, and no out-of-limit commands occur.

In some embodiments, the processor queries a preset table based on current parameter values of the extraction device to determine amplitude variation thresholds. The processor determines target variation amounts based on target parameter values in the optimal adjustment strategy and the current parameter values. In response to the target variation amounts being greater than the amplitude variation thresholds, the processor performs a plurality of stepwise adjustments on the extraction device according to the amplitude variation thresholds until parameters of the extraction device reach the target parameter values.

The current parameter value refers to a key control parameter under a current operating state of the extraction device before performing adjustment. In some embodiments, the current parameter value includes a current first temperature value of the extraction device (i.e., a current temperature inside a leaching reaction kettle), a current first pH value (i.e., a current acidity or alkalinity of a solution), a current first stirring speed (i.e., a current rotational speed of a stirring motor), and a current first quality index (output by an iron phosphate quality analysis model and used to measure a current extraction effect quality).

The amplitude variation threshold refers to a maximum single parameter adjustment amplitude that is safely accepted.

In some embodiments, the amplitude variation threshold is used to limit a change amplitude of key control parameters such as the first temperature value, the first pH value, and the first stirring speed, avoiding instability in the extraction process caused by overly rapid or large adjustments.

In some embodiments, the amplitude variation threshold includes three safety thresholds: T₀, pH₀, and S₀.

For example, there are four input factors for table lookup: the first temperature value, the first pH value, the first stirring speed, and the first quality index. The amplitude variation threshold output from the table lookup includes three parameters: T₀, pH₀, and S₀.

The preset table includes a relationship between the current parameter value and the amplitude variation threshold. In some embodiments, the preset table is preset by a technician based on experience.

The target parameter value refers to a specific parameter in the optimal adjustment strategy used to replace the current parameter value. For example, the target parameter value is the first temperature value (i.e., Tₚ), the first pH value (i.e., pHₚ), and the first stirring speed (i.e., Sₚ) in the optimal adjustment strategy.

The target variation amount refers to a difference between the target parameter value and the current parameter value. For example, the target variation amount includes three differences: ΔT, ΔpH, and ΔS.

In some embodiments, the processor uses an absolute value of the difference between the target parameter value and the current parameter value as the target variation amount.

In some embodiments, the processor splits the target variation amount according to the amplitude variation threshold to determine a required number of stepwise adjustments. An adjustment amount for each step does not exceed the amplitude variation threshold (i.e., the temperature adjustment amount does not exceed T₀, the pH adjustment amount does not exceed pH₀, and the stirring speed adjustment amount does not exceed S₀). The plurality of adjustments will be performed until the current parameter value reaches the target parameter value.

In some embodiments, by introducing independent maximum variation amplitude limits (ΔT, ΔpH, ΔS) for different control parameters, the adjustment process becomes more precise and controllable. This effectively avoids temperature shock, pH change, or stirring disturbance caused by one-time large adjustments, thereby improving the stability of the extraction process and the product purity.
Step S5, a second extraction instruction is received, a second quality index of the extraction device at time T₂+b in a second extraction stage is obtained, and whether the extraction device is in an abnormal extraction state at the time T₂+b is determined based on the second quality index. It is known that there are two situations where the extraction device is in the abnormal extraction state and the extraction device is not in the abnormal extraction state, i.e., in a normal state. In response to determining that the extraction device is in the abnormal extraction state, a second extraction adjustment instruction is generated, and step S6 is jumped to. In response to determining that the extraction device is not in the abnormal extraction state, extraction is continued until the extraction of lithium carbonate is completed.

It should be noted that the second quality index specifically refers to a purity of lithium carbonate recovered by extraction in the second extraction stage, which is obtained by measurement ways such as ICP-OES or XRF.

In some embodiments, the processor obtains a second extraction control index of the extraction device at time T₂+b and second characteristic data of an extraction mixture in the extraction device and labels them as lithium carbonate feature data. The second characteristic data include a lithium ion concentration, a viscosity of the extraction mixture, and an impurity percentage. The lithium carbonate feature data is input into a pre-built lithium carbonate quality analysis model to obtain the second quality index at time T₂+b.

The second extraction control index refers to a parameter that controls the extraction device to perform extraction in the second extraction stage. The second extraction stage refers to a stage for obtaining high-purity lithium carbonate.

In some embodiments, the processor obtains the second extraction control index of the extraction device at time T₂+b through the following steps d1 to d3.
Step d1, second parameter characteristic data at time T₂ is collected.

The second parameter characteristic data refer to parameters characterizing an operating state of the extraction device in the second extraction stage.

In some embodiments, the second parameter characteristic data include a second temperature value, a second pH value, and a second stirring speed. The second temperature value refers to a temperature value of the extraction device in the second extraction stage. The second pH value refers to a pH value in the extraction device in the second extraction stage. The second stirring speed refers to a stirring speed of the extraction device in the second extraction stage.

In some embodiments, the processor marks the second temperature value, the second pH value, and the second stirring speed as Wₛ₂, Ph₂, and Sd₂, respectively.

It should be noted that the second temperature value is obtained by collection via a temperature sensor connected to a temperature control system. The second pH value is obtained by collection via a pH meter connected to a pH automatic control system. The second stirring speed is obtained by collection via a speed sensor connected to an automatic stirring system. Details related to the temperature control system, the pH automatic control system, and the automatic stirring system may be found in FIG. 1 and the related descriptions thereof.
Step d2, based on the first extraction control index, a calculation is performed on the second parameter characteristic data to obtain the second extraction control index at time T₂. The calculation formula is:

$${θ}_{2} = {θ}_{1} - ( W {s}_{2} \times {β}_{1} + P {h}_{2} \times {β}_{2} + S {d}_{2} \times {β}_{3} ) + ( {μ}_{2} \times W {s}_{2} \times P {h}_{2} )$$

In the formula, θ₂ represents the second extraction control index, Ws₂ represents the second temperature value, β₁ represents a weight factor of the second temperature value, Ph₂ represents the second pH value, β₂ represents a weight factor of the second pH value, Sd₂ represents the second stirring speed, β₃ represents a weight factor of the second stirring speed, and μ₂ represents the weighting coefficient of interaction between the second temperature value and the second pH value.

It should be noted that a larger value of μ₂ indicates that the interaction between temperature and pH value has a more significant impact on extraction efficiency. The calculation of the second extraction control index is a dimensionless calculation.

Furthermore, β₁, β₂, and β₃ are weight factors set based on actual conditions. μ₂ is determined by a technician based on historical data. The weight factors reflect the degree of influence of each type of second parameter characteristic data on the actual extraction purity of lithium carbonate by the extraction device. A person skilled in the art presets corresponding weight factors according to the degree of influence of each type of second parameter characteristic data on the actual extraction purity of lithium carbonate by the extraction device, so as to accurately evaluate the actual extraction purity of lithium carbonate by the extraction device.
Step d3, the second extraction control index at time T₂ is input into a pre-built parameter analysis model to predict the second extraction control index at time T₂+b.

In some embodiments, the processor labels the second quality index at time T₂+b predicted by the pre-built lithium carbonate quality analysis model (also referred to as the lithium carbonate quality analysis model) as Zlz. A second index threshold is preset. The preset second index threshold includes Y₁ and Y₂, where Y₁>Y₂. The second quality index is compared with the preset second index threshold. If Zlz>Y₁ or Zlz<Y₂, the extraction device at time T₂+b is determined to be in an abnormal extraction state. If Y₁≥Zlz≥Y₂, the extraction device at time T₂+b is determined to be in a normal extraction state, and extraction is continued using the second parameter characteristic data corresponding to the second extraction control index to obtain high-purity lithium carbonate.

The second index threshold refers to a parameter used to determine whether the extraction device is in an abnormal state during the second extraction stage. In some embodiments, the second index threshold includes two values, Y₁ and Y₂, where Y₁>Y₂.

In some embodiments, the second index threshold is determined by a technician based on historical data.

The extraction mixture refers to a solution obtained after removing iron ions and adding a second extractant following the first extraction stage. The second extractant is a Na₂CO₃ solution.

The second characteristic data refers to data reflecting characteristics of the extraction mixture.

In some embodiments, the second characteristic data includes the lithium ion concentration, the viscosity of the extraction mixture, and the impurity percentage.

It should be noted that the way of obtaining the second characteristic data is the same as the way of obtaining the first characteristic data, and is not redundantly described here. Notably, the impurity ion concentration of the mixture includes concentrations of copper, zinc, and iron ions.

The lithium carbonate feature data refers to data reflecting the quality of the extraction operation condition in the second extraction stage and the quality of the extraction mixture.

In some embodiments, the processor combines the second extraction control index and the second characteristic data to construct the iron phosphate feature data.

The lithium carbonate quality analysis model refers to a model used to obtain the second quality index. In some embodiments, the lithium carbonate quality analysis model is a deep neural network model or a deep belief network model.

In some embodiments, an input of the lithium carbonate quality analysis model is the lithium carbonate feature data, and an output is the second quality index.

In some embodiments, the processor trains the iron phosphate quality analysis model in a plurality of ways.

In some embodiments, the processor converts each set of lithium carbonate feature data into a form of a second feature vector. Elements of all second feature vectors serve as inputs to the lithium carbonate quality analysis model. The lithium carbonate quality analysis model uses the second quality index predicted for each set of lithium carbonate feature data as an output. An actual second quality index corresponding to each set of lithium carbonate feature data serves as a prediction target. A sum of second prediction accuracies of all predicted second quality indices serves as a training objective. The lithium carbonate quality analysis model is trained until the sum of the second prediction accuracies reaches convergence, at which point training stops.

The second feature vector refers to a vector reflecting the lithium carbonate feature data. In some embodiments, elements in the second feature vector are the lithium carbonate feature data.

In some embodiments, the processor converts the lithium carbonate feature data into the second feature vector based on a vector conversion way.

In some embodiments, the processor uses the actual second quality index corresponding to each set of lithium carbonate feature data as the prediction target.

In some embodiments, the training objective is for the sum of the second prediction accuracies of all predicted second quality indices to reach a minimum value.

In some embodiments, a calculation formula for the second prediction accuracy is:

$${Z}_{2} = {( {b}_{m} - {s}_{m} )}^{2} .$$

where m is a serial number of each set of lithium carbonate feature data, Z₂ is the second prediction accuracy, bₘ is the predicted second quality index corresponding to the m-th set of lithium carbonate feature data, and sₘ is the actual second quality index corresponding to the m-th set of lithium carbonate feature data.

In some embodiments, the processor trains the lithium carbonate quality analysis model based on a plurality of third training samples with prediction targets. A third training sample includes a historical second feature vector. A prediction target corresponding to the third training sample is an actual historical second quality index corresponding to historical lithium carbonate feature data. The prediction target is determined by a technician based on historical data.

In some embodiments, the way for training the lithium carbonate quality analysis model is the same as the way for training the iron phosphate quality analysis model, and is not repeated here.

The second extraction adjustment instruction refers to an instruction generated based on the second quality index for adjusting the abnormal extraction state of the extraction device. For example, the second extraction adjustment instruction is to increase the temperature to 58° C., increase the pH value to 4.8, and decrease the stirring speed to 70 rpm.

In some embodiments, in response to determining that the extraction device is not in the abnormal extraction state, the processor generates a second extraction instruction.

It should be noted that, in the second extraction stage, a second extractant of a preset concentration is added to the leach solution from which iron phosphate has been extracted, and the resulting mixture is marked as the extraction mixture. The second extractant is a sodium carbonate solution (i.e., Na₂CO₃) serving as a selective extractant for lithium. The purpose of setting the second extraction stage is to optimize precipitation efficiency of lithium carbonate extraction under different chemical conditions, avoid impurity generation, improve product purity, and simultaneously ensure the stability and a high recovery rate of this extraction stage. Conditions of the second extraction stage, such as pH value, temperature, and stirring speed, are precisely controlled for the extraction mixture, thereby ensuring optimal extraction purity of lithium carbonate.
Step S6, the second extraction adjustment instruction is received, and the extraction device is adjusted based on the second quality index to obtain high-purity lithium carbonate.

In some embodiments, the processor determines a target second temperature value, a target second pH value, and a target second stirring speed for the extraction device according to the second quality index. According to the target second temperature value, a heat transfer fluid in a coil is controlled to circulate to perform temperature adjustment on the extraction mixture. According to the target second pH value, an acid-base titration pump is controlled to perform titration to perform pH adjustment on the extraction mixture. According to the target second stirring speed, a stirring motor is controlled to stir the extraction mixture.

The target second temperature value refers to a control temperature value determined for the extraction device to optimize the precipitation and separation effect of lithium carbonate in the second extraction stage.

The target second pH value refers to a control pH value determined for the extraction device to optimize the precipitation and separation effect of lithium carbonate in the second extraction stage.

The target second stirring speed refers to a control stirring speed determined for the extraction device to optimize the precipitation and separation effect of lithium carbonate in the second extraction stage.

In some embodiments, the processor simulates the second quality index output under a plurality of different combinations of temperature, pH, and stirring speed, and selects the combination of temperature, pH, and stirring speed corresponding to the highest quality index value as the target second temperature value, the target second pH value, and the target second stirring speed. The way for obtaining the second quality index by simulating different combinations of temperature, pH, and stirring speed is similar to steps c1-c10 and will not be repeated here.

A coil refers to a heating component that covers an outer wall of a leaching reaction kettle. In some embodiments, the processor adjusts a temperature of the extraction mixture in the leaching reaction kettle through a heat transfer oil circulation way based on the coil.

In some embodiments, if a current temperature is lower than the target second temperature value, the processor increases a circulation intensity of a heat transfer fluid (e.g., the heat transfer fluid is heat transfer oil) to accelerate heating. If the current temperature is higher than the target second temperature value, the processor reduces a flow rate of the heat transfer fluid to achieve cooling adjustment.

The acid-base titration pump refers to the acid-base titration component. In some embodiments, the processor performs automatic titration of a trace amount of acid or base based on real-time pH monitoring results to adjust the acidity and alkalinity of the extraction mixture.

A stirring motor refers to the power device that drives the stirring paddle in the leaching reaction kettle to rotate.

In some embodiments, using the target parameter value determined based on the second quality index to adjust the extraction process enables the adjustment process to be fast and accurate, thereby improving the extraction purity of lithium carbonate in a relatively short time.

It should be noted that adjusting the extraction device based on the second quality index is the same as the way of adjusting the extraction device based on the first quality index in Step S4, and will not be elaborated here. It is worth noting that in the second extraction stage, a value range of the second temperature value in the second parameter characteristic data is [50° C., 70° C.], a value range of the second pH value is [8, 10], and a value range of the second stirring speed is [50 rpm, 150 rpm]. Similar to Step S4, the current parameter value starts from a minimum value in simulation until the optimal adjustment strategy is obtained.

In some embodiments, the value range of the second temperature value in the second parameter characteristic data is one of [50° C., 55° C.], [55° C., 60° C.], [60° C., 65° C.], or [65° C., 70° C.].

In some embodiments, the value range of the second pH value in the second parameter characteristic data is one of [8, 8.5], [8.5, 9], [9, 9.5], or [9.5, 10].

In some embodiments, the value range of the second stirring speed in the second parameter characteristic data is one of [50 rpm, 70 rpm], [70 rpm, 90 rpm], [90 rpm, 110 rpm], [110 rpm, 130 rpm], or [130 rpm, 150 rpm].

In some embodiments, obtaining the first extraction control index and the first characteristic data of the extraction device at time T₁+a and inputting them into the iron phosphate quality analysis model enables real-time prediction of the separation effect of iron phosphate in the first extraction stage. Obtaining the second extraction control index and the second characteristic data of the extraction device at time T₂+b and inputting them into the lithium carbonate quality analysis model enables real-time prediction of the separation effect of lithium carbonate in the second extraction stage. Based on different extraction stages and a precise extraction control way, errors in the operation process are effectively reduced, ensuring that optimal temperature, pH value, and stirring speed are achieved during the extraction process, thereby improving product purity and recovery rate.

In some embodiments, the extraction state is predicted in real time through the quality analysis models, and a warning of the abnormal extraction state is generated. When the extraction device is in the abnormal extraction state, the system automatically generates the extraction adjustment instruction and performs adjustment according to the optimal adjustment strategy, ensuring that the extraction process is timely restored to the normal extraction state and reducing uncontrollable risks in the operation.

The foregoing descriptions are merely specific implementations of the present disclosure, but the protection scope of the present disclosure is not limited thereto. Any person skilled in the art can easily conceive of changes or substitutions within the technical scope disclosed in the present disclosure, which should fall within the protection scope of the present disclosure. Therefore, the protection scope of the present disclosure shall be subject to the protection scope of the claims.

Finally, the foregoing descriptions are merely preferred embodiments of the present disclosure and are not intended to limit the present disclosure. Any modification, equivalent replacement, or improvement made within the spirit and principle of the present disclosure shall be included in the protection scope of the present disclosure.

What is claimed is:

1. A method for extracting and recovering high-purity lithium carbonate and iron phosphate from a spent lithium battery material, comprising:
step S1: in a first extraction stage, obtaining a first extraction control index of an extraction device at time T₁+a, and obtaining first characteristic data of a leach solution in the extraction device; labeling a combination of the first extraction control index and the first characteristic data as iron phosphate feature data; wherein T₁ and a are both integers greater than zero, and the first characteristic data includes an iron ion concentration, a viscosity of the leach solution, and an impurity percentage of the leach solution;
step S2: inputting the iron phosphate feature data into a pre-built iron phosphate quality analysis model to obtain a first quality index at the time T₁+a;
step S3: determining, based on the first quality index, whether the extraction device is in an abnormal extraction state at the time T₁+a; in response to determining that the extraction device is in the abnormal extraction state, generating an extraction adjustment instruction and jumping to step S4; in response to determining that the extraction device is not in the abnormal extraction state, generating a second extraction instruction and jumping to step S5;
step S4: according to the extraction adjustment instruction, adjusting the extraction device based on the first quality index to optimize an extraction process and obtain high-purity iron phosphate;
step S5: receiving the second extraction instruction, obtaining a second quality index of the extraction device at time T₂+b in a second extraction stage, and determining, based on the second quality index, whether the extraction device is in the abnormal extraction state at the time T₂+b; in response to determining that the extraction device is in the abnormal extraction state, generating a second extraction adjustment instruction and jumping to step S6; in response to determining that the extraction device is not in the abnormal extraction state, continuing extraction until extraction of lithium carbonate is completed; and
step S6: receiving the second extraction adjustment instruction, and adjusting the extraction device based on the second quality index to obtain high-purity lithium carbonate;
wherein the obtaining the first extraction control index of the extraction device at the time T₁+a includes:
step a1: collecting first parameter characteristic data at time T₁, the first parameter characteristic data including a first temperature value, a first pH value, and a first stirring speed; labeling the first temperature value, the first pH value, and the first stirring speed as Wₛ₁, Ph₁, and Sd₁, respectively;
step a2: performing a calculation on the first parameter characteristic data to obtain the first extraction control index at the time T₁, a calculation formula thereof being:
$${θ}_{1} = ( W {s}_{1} \times {α}_{1} + P {h}_{1} \times {α}_{2} + S {d}_{1} \times {α}_{3} ) + ( {μ}_{1} \times W {s}_{1} \times P {h}_{1} ) ;$$
where θ₁ represents the first extraction control index at the time T₁, α₁ represents a weight factor of the first temperature value, α₂ represents a weight factor of the first pH value, α₃ represents a weight factor of the first stirring speed, and μ₁ represents a weighting coefficient of an interaction between the first temperature value and the first pH value; and
step a3: inputting the first extraction control index at the time T₁ into a pre-built parameter analysis model to predict the first extraction control index at the time T₁+a;
wherein the obtaining the second quality index of the extraction device at the time T₂+b includes:
obtaining a second extraction control index of the extraction device at the time T₂+b and second characteristic data of an extraction mixture in the extraction device, and labeling a combination of the second extraction control index and the second characteristic data as lithium carbonate feature data; wherein the second characteristic data includes a lithium ion concentration, a viscosity of the extraction mixture, and an impurity percentage of the extraction mixture; and
inputting the lithium carbonate feature data into a pre-built lithium carbonate quality analysis model to obtain the second quality index at the time T₂+b;
wherein the obtaining the second extraction control index of the extraction device at the time T₂+b includes:
step d1: collecting second parameter characteristic data at the time T₂, the second parameter characteristic data including a second temperature value, a second pH value, and a second stirring speed; labeling the second temperature value, the second pH value, and the second stirring speed as Ws₂, Ph₂, and Sd₂, respectively;
step d2: performing, based on the first extraction control index, a calculation on the second parameter characteristic data to obtain the second extraction control index at the time T2, a calculation formula thereof being:
$${θ}_{2} = {θ}_{1} - ( W {s}_{2} \times {β}_{1} + P {h}_{2} \times {β}_{2} + S {d}_{2} \times {β}_{3} ) + ( {μ}_{2} \times W {s}_{2} \times P {h}_{2} ) ;$$
where θ₂ represents the second extraction control index, β₁ represents a weight factor of the second temperature value, β₂ represents a weight factor of the second pH value, β₃ represents a weight factor of the second stirring speed, and μ₂ represents a weighting coefficient of an interaction between the second temperature value and the second pH value; and
step d3: inputting the second extraction control index at the time T₂ into the pre-built parameter analysis model to predict the second extraction control index at the time T₂+b.

2. The method according to claim 1, wherein the adjusting the extraction device based on the second quality index includes:
determining a target second temperature value, a target second pH value, and a target second stirring speed of the extraction device according to the second quality index;
according to the target second temperature value, controlling a heat transfer fluid in a coil to circulate to perform temperature adjustment on the extraction mixture;
according to the target second pH value, controlling an acid-base titration pump to perform titration to perform pH adjustment on the extraction mixture; and
according to the target second stirring speed, controlling a stirring motor to stir the extraction mixture.

3. The method according to claim 1, wherein a generation process of the pre-built parameter analysis model includes:
obtaining a historical first extraction control index, and establishing an extraction time series set based on the historical first extraction control index, the extraction time series set including u historical first extraction control indices, wherein the u historical first extraction control indices are obtained at equal time intervals, and the u historical first extraction control indices correspond to a preset time; wherein a unit of the preset time is second or minute; and
presetting a sliding step size and a sliding window length; using a sliding window manner to convert the u historical first extraction control indices in the extraction time series set into a plurality of training samples, using the plurality of training samples as input of a recurrent neural network model (RNN model), predicting a first extraction control index after the sliding step size as output, using the first extraction control index of each training sample of the plurality of training samples as a prediction target, and using a prediction accuracy as a training objective to train the RNN model; generating the pre-built parameter analysis model that predicts a first extraction control index at a future time according to the u historical first extraction control indices in the extraction time series set.

4. The method according to claim 3, wherein the method further comprises:
determining an extraction sub-stage to which the extraction process belongs according to a fluctuation degree of the first extraction control index within the preset time, the extraction sub-stage including an initial reaction stage, an intermediate stabilization stage, and a final finishing stage;
determining the sliding window length and the sliding step size according to a current extraction sub-stage, including:
in response to the current extraction sub-stage being the initial reaction stage, determining the sliding window length as a first window length and the sliding step size as a first step size;
in response to the current extraction sub-stage being the intermediate stabilization stage, determining the sliding window length as a second window length and the sliding step size as a second step size;
in response to the current extraction sub-stage being the final finishing stage, determining the sliding window length as a third window length and the sliding step size as a third step size;
wherein the first window length is greater than the third window length, the second window length is less than the third window length, the second step size is greater than the third step size, and the first step size is less than the third step size.

5. The method according to claim 3, wherein the iron ion concentration is obtained by directly analyzing a concentration of iron ions through a concentration analysis device; the viscosity of the leach solution is measured by a rotational viscometer or a capillary viscometer; a process for obtaining the impurity percentage of the leach solution includes:
step b1: collecting a leach solution sample and analyzing an impurity ion concentration through the concentration analysis device; the impurity ion concentration including concentrations of copper, zinc, and lithium ions;
step b2: determining a mass of impurity ions: mᵢ=Cᵢ×V, where mᵢ represents a mass of an i-th impurity ion, Cᵢ represents a concentration of the i-th impurity ion; V represents a volume of the leach solution sample;
step b3: summing masses of all the impurity ions to obtain a total mass of the impurity ions: mₜₒₜₐₗ=mᵢ, and
step b4: obtaining a total mass M_{leach solution} of the leach solution sample, and determining the impurity percentage Zbf according to the total mass mₜₒₜₐₗ of the impurity ions and the total mass M_{leach solution} of the leach solution sample:
$$Z b f = \frac{{m}_{total}}{{M}_{leach solution}} \times 100 \% .$$

6. The method according to claim 5, wherein a generation process of the pre-built iron phosphate quality analysis model includes:
converting each set of iron phosphate feature data into a form of a first feature vector, using elements of all first feature vectors as input of the pre-built iron phosphate quality analysis model, using a first quality index predicted by each set of the iron phosphate feature data as output of the pre-built iron phosphate quality analysis model, using an actual first quality index corresponding to each set of the iron phosphate feature data as a prediction target, and using minimizing a sum of first prediction accuracies of all predicted first quality indices as a training objective; wherein a calculation formula of the first prediction accuracy is: Z₁=(aₙ−yₙ)², wherein n is a serial number of each set of iron phosphate feature data, Z₁ is the first prediction accuracy, aₙ is a predicted first quality index corresponding to an n-th set of iron phosphate feature data, and yₙ is an actual first quality index corresponding to the n-th set of iron phosphate feature data; training the pre-built iron phosphate quality analysis model until the sum of the first prediction accuracies reaches convergence and stopping training; wherein the pre-built iron phosphate quality analysis model is a deep neural network model or a deep belief network model.

7. The method according to claim 6, wherein the determining whether the extraction device is in the abnormal extraction state at the time T₁+a includes:
labeling the first quality index at the time T₁+a predicted by the pre-built iron phosphate quality analysis model as Zls; and presetting a first index threshold, the first index threshold including S₁ and S₂, wherein S₁>S₂;
comparing the first quality index with the first index threshold;
if Zls>S₁ or Zls<S₂, determining that the extraction device is in the abnormal extraction state at the time T₁+a; or
if S₁≥Zls≥S₂, determining that the extraction device is in a normal extraction state at the time T₁+a, continuing to complete extraction with the first parameter characteristic data corresponding to the first extraction control index, and entering the second extraction stage.

8. The method according to claim 1, wherein the adjusting the extraction device based on the first quality index includes:
inputting the first parameter characteristic data corresponding to the first quality index into a pre-built digital twin model for simulation to obtain an optimal adjustment strategy;
a process for obtaining the optimal adjustment strategy includes:
step c1. obtaining the first parameter characteristic data of the extraction device, taking the first pH value and the first stirring speed in the first parameter characteristic data as fixed quantities, taking the first temperature value as a variable, and taking a current parameter value of the first temperature value as W;
step c2. setting W=W+D₁, and recording a first quality index under parameter value W, wherein D₁ is a natural number greater than zero;
step c3. repeating and cycling step c2, when W is equal to a preset first temperature threshold, obtaining G first quality indices under the parameter value W, and jumping to step c4, wherein G is an integer greater than zero;
step c4. taking the first temperature value and the first stirring speed as fixed quantities, taking the first pH value as a variable, and taking a current parameter value of the first pH value as U;
step c5. resetting W, setting U=U+D₂, and recording the first quality index under parameter value U, wherein D₂ is a natural number greater than zero;
step c6. repeating and cycling step c5, when U is equal to a preset first pH threshold, obtaining H first quality indices under the parameter value U, wherein H is an integer greater than zero;
step c7. taking the first temperature value and the first pH value as fixed quantities, taking the first stirring speed as a variable, and taking a current parameter value of the first stirring speed as F;
step c8. resetting U, setting F=F+D₃, and recording the first quality index under parameter value F, wherein D₃ is a natural number greater than zero;
step c9. repeating and cycling step c8, when F is equal to a preset first stirring speed threshold, obtaining K first quality indices under the parameter value F, wherein K is an integer greater than zero;
step c10. marking the G first quality indices under the parameter value W, the H first quality indices under the parameter value U, and the K first quality indices under the parameter value F as the first extraction control data, accumulating and integrating on the first extraction control data to obtain L first quality indices, and sorting the L first quality indices in descending order of numerical value; and
step c11. taking the first temperature value, the first pH value, and the first stirring speed of the extraction device corresponding to a first quality index having a largest numerical value in the sorting as the optimal adjustment strategy.

9. The method for extracting and recovering high-purity lithium carbonate and iron phosphate from a spent lithium battery material according to claim 1, wherein the method further includes:
querying a preset table according to current parameter values of the extraction device to determine amplitude variation thresholds, wherein the current parameter values includes a current first temperature value, a current first pH value, a current first stirring speed, and a current first quality index;
determining target variation amounts according to target parameter values in an optimal adjustment strategy and the current parameter values; and
in response to the target variation amounts being greater than the amplitude variation thresholds, performing a plurality of stepwise adjustments on the extraction device according to the amplitude variation thresholds until parameters of the extraction device reaches the target parameter values.

10. The method for extracting and recovering high-purity lithium carbonate and iron phosphate from a spent lithium battery material according to claim 8, wherein, in the first extraction stage, a value range of the first temperature value in the first parameter characteristic data is [40° C., 60° C.], a value range of the first pH value is [3, 5], and a value range of the first stirring speed is [100 rpm, 300 rpm]; and in the second extraction stage, a value range of the second temperature value in the second parameter characteristic data is [50° C., 70° C.], a value range of the second pH value is [8, 10], and a value range of the second stirring speed is [50 rpm, 150 rpm].

11. The method for extracting and recovering high-purity lithium carbonate and iron phosphate from a spent lithium battery material according to claim 10, wherein a generation method of the pre-built lithium carbonate quality analysis model includes:
converting each set of lithium carbonate feature data into a form of a second feature vector, taking elements of all second feature vectors as an input of the pre-built lithium carbonate quality analysis model, the pre-built lithium carbonate quality analysis model taking a predicted second quality index of each set of lithium carbonate feature data as an output, taking an actual second quality index corresponding to each set of lithium carbonate feature data as a prediction target, and taking minimizing a sum of second prediction accuracies of all predicted second quality indices as a training objective; wherein a calculation formula of the second prediction accuracy is: Z₂=(bₘ−sₘ)², wherein m is a serial number of each set of lithium carbonate feature data, Z₂ is the second prediction accuracy, bₘ is the predicted second quality index corresponding to an m-th set of lithium carbonate feature data, and sₘ is the actual second quality index corresponding to the m-th set of lithium carbonate feature data; training the pre-built lithium carbonate quality analysis model until the sum of the second prediction accuracies reaches convergence and then stopping training; and the pre-built lithium carbonate quality analysis model is a deep neural network model or a deep belief network model.

12. The method for extracting and recovering high-purity lithium carbonate and iron phosphate from a spent lithium battery material according to claim 1, wherein the determining whether the extraction device is in the abnormal extraction state at time T₂+b includes:
marking the second quality index at the time T₂+b predicted by the pre-built lithium carbonate quality analysis model as Zlz; and presetting a second index threshold, wherein the second index threshold includes Y₁ and Y₂, and Y₁>Y₂;
comparing the second quality index with the second index threshold;
if Zlz>Y₁ or Zlz<Y₂, determining that the extraction device is in the abnormal extraction state at the time T₂+b;
if Y≥Zlz≥Y₂, determining that the extraction device is in the normal extraction state at the time T₂+b, and continuing to complete extraction with the second parameter characteristic data corresponding to the second extraction control index to obtain the high-purity lithium carbonate.
